(19) United States
(12) Patent Application Publication
(10) Pub. No.: US 2010/0176312 A1
(43) Pub. Date: Jul. 15, 2010

(54) EXTREME ULTRA VIOLET LIGHT SOURCE APPARATUS

(76) Inventors: Hiroshi Komori, Hiratsuka (JP); Yoshifumi Ueno, Hiratsuka (JP); Georg Soumagne, Kamakura-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/352,694

(22) Filed: Jan. 13, 2009

(51) Int. Cl. G01J 3/10

(52) U.S. Cl. 250/504 R

(57) ABSTRACT

In a laser produced plasma type extreme ultra violet light source apparatus, charged particles such as ions emitted from plasma can be efficiently ejected by the action of a magnetic field and secondary production of contaminants can be suppressed. The extreme ultra violet light source apparatus includes: a target nozzle for supplying a target material; a laser oscillator for applying a laser beam to the target material supplied by the target nozzle to generate plasma; an EUV collector mirror for collecting extreme ultra violet light radiated from the plasma; and an electromagnet for forming a magnetic field in a position where the laser beam is applied to the target material, wherein an aperture of the electromagnet is formed according to a shape of lines of magnetic flux of the magnetic field.

### BACKGROUND OF THE INVENTION

1. Field of the Invention

The present invention relates to an extreme ultra violet (EUV) light source apparatus to be used as a light source of exposure equipment.

2. Description of a Related Art

Recent years, as semiconductor processes become finer, photolithography has been making rapid progress to finer fabrication. In the next generation, microfabrication of 100 nm to 70 nm, further, microfabrication of 50 nm or less will be required. Accordingly, in order to fulfill the requirement for microfabrication of 50 nm or less, for example, exposure equipment is expected to be developed by combining an EUV light source generating EUV light with a wavelength of about 13 nm and reduced projection reflective optics.

As the EUV light source, there are three kinds of light sources, which include an LPP (laser produced plasma) light source using plasma generated by applying a laser beam to a target (hereinafter, also referred to as “LPP type EUV light source apparatus”, a DPP (discharge produced plasma) light source using plasma generated by discharge, and an SR (synchrotron radiation) light source using orbital radiation. Among them, the LPP type EUV light source apparatus has advantages that extremely high intensity close to black body radiation can be obtained because plasma density can be considerably made larger, that light emission of only the necessary waveband can be performed by selecting the target material, and that an extremely large collection solid angle of 2π steradian can be ensured because it is a point source having substantially isotropic angle distribution and there is no structure surrounding the light source such as electrodes. Therefore, the LPP type EUV light source apparatus is considered to be predominant as a light source for EUV lithography requiring power of more than several tens of watts.

FIG. 13 is a diagram for explanation of a principle of generating EUV light in the LPP type EUV light source apparatus. An EUV light source apparatus shown in FIG. 13 includes a laser oscillator 901, a focusing optics 902 such as a collective lens and so on, a target supply unit 903, a target nozzle 904, and an EUV collector mirror 905. The laser oscillator 901 is a laser light source that pulse-oscillating a laser beam for exciting a target material. The collective lens 902 collects the laser beam outputted from the laser oscillator 901 in a predetermined position. Further, the target supply unit 903 supplies the target material to the target nozzle 904, and the target nozzle 904 injects the supplied target material to the predetermined position.

When the laser beam is applied to the target material injected from the target nozzle 904, the target material is ionized and plasma is generated, and various wavelength components are radiated from the plasma.

The EUV collector mirror 905 has a concave reflection surface that reflects and collects the light radiated from the plasma. A film in which molybdenum and silicon are alternately stacked (Mo/Si multilayer film), for example, is formed on the reflection surface for selective reflection of a predetermined wavelength component (e.g., near 13.5 nm). Thereby, the predetermined wavelength component radiated from the plasma is outputted to exposure equipment or the like as output EUV light.

In the LPP type EUV light source apparatus, there is a problem of the influence by charged particles such as fast ions emitted from plasma. This is because the EUV collector mirror 905 is located relatively near the plasma emission point (the position where the laser beam is applied to the target material), and thus, the fast ions and so on collide with the EUV collector mirror 905 and the reflection surface (Mo/Si multilayer film) of the mirror is sputtered and damaged. Here, in order to improve the EUV light utilization efficiency, it is necessary to keep the reflectance of the EUV collector mirror 905 high. For the purpose, high flatness is required for the reflection surface of the EUV collector mirror 905, and the mirror becomes very expensive. Accordingly, longer life of the EUV collector mirror 905 is desired in view of reduction in operation cost of the exposure system including the EUV light source apparatus, reduction in maintenance time, and so on.

As a related technology, U.S. Pat. No. 6,987,279 B2 discloses a light source device including a target supply unit for supplying a material to become the target, a laser unit for generating plasma by applying a laser beam to the target, a collection optical system for collecting the extreme ultra violet light radiating from the plasma and emitting the extreme ultra violet light, and magnetic field generating unit for generating a magnetic field within the collection optical system when supplied with current so as to trap charged particles radiating from the plasma (page 1, FIG. 1). In the light source device, ions radiating from the plasma are trapped near the plasma by forming a mirror magnetic field using Helmholtz electromagnets (column 6, FIG. 4). Thereby, the damage on the EUV collector mirror by so-called debris of ions and so on is prevented.

Now, referring to FIG. 14, generally, when no iron cores are provided in electromagnets 911 and 912, a magnetic field in which lines of magnetic flux 914 are converged within apertures 913 is formed. On the other hand, as shown in FIG. 15, when iron cores 923 are provided in electromagnets 921 and 922, a magnetic field in which lines of magnetic flux 925 are diverged within apertures 924 is formed. Here, in U.S. Pat. No. 6,987,279 B2, ions are ejected through the center aperture of the electromagnets to the outside of the EUV collector mirror (see FIG. 1 of U.S. Pat. No. 6,987,279 B2), the shape of the apertures is a cylindrical shape having the same diameter on the upper surface and the lower surface. Accordingly, part of the lines of the magnetic flux cut through the bottom surfaces and the wall surfaces of the apertures of the electromagnets, and the ions ejected along the lines of the magnetic flux collide with the bottom surfaces and the wall surfaces of the apertures of the electromagnets. Thereby, the ion flow is hindered and the ejection speed of the ions becomes lower. Further, when the ions collide with the electromagnets, charge exchange occurs and the ions are neutralized, and also the ejection efficiency of ions (debris) becomes lower. As a result, when EUV light is generated at a high repetition frequency, especially, the concentration of ions and neutral particles staying near the plasma emission point becomes higher. Here, generally, the ions and atoms of the target material absorb the generated EUV light. If the concentration of ions and atoms rises, available EUV light is reduced.

Further, since the bottom surfaces of the electromagnets or the wall surfaces of the apertures are damaged due to collision with ions, deterioration of the electromagnets progresses and the sputtered materials (surface materials of the electromagnets) fly and attach to components within the chamber. If the newly produced contaminant attaches to the reflection surface of the EUV collector mirror, the reflectance of the mirror becomes lower and a problem of lower EUV light utilization efficiency arises.

### SUMMARY OF THE INVENTION

The present invention has been achieved in view of the above-mentioned problems. A purpose of the present invention is to efficiently eject charged particles such as ions emitted from plasma by the action of a magnetic field and suppress production of a new contaminant in a laser produced plasma type extreme ultra violet light source apparatus.

In order to accomplish the above-mentioned purpose, an extreme ultra violet light source apparatus according to one aspect of the present invention is a laser produced plasma type extreme ultra violet light source apparatus including: a target nozzle for supplying a target material; a laser oscillator for applying a laser beam to the target material supplied by the target nozzle to generate plasma; a collecting optics for collecting extreme ultra violet light radiated from the plasma; and magnetic field forming means for forming a magnetic field in a position where the laser beam is applied to the target material, wherein an aperture of the magnetic field forming means is formed according to a shape of lines of magnetic flux of the magnetic field.

According to the present invention, since the aperture of the magnetic field forming means is formed according to the shape of lines of magnetic flux such that the lines of the magnetic flux may not cut through the magnetic field forming means, when the charged particles such as ions emitted from plasma are ejected by the action of the magnetic field, they hardly collide with the magnetic field forming means. Thereby, the movement flow of the charged particles is not hindered, and the charged particles can be quickly ejected from the vicinity of the EUV collector mirror and the plasma emission point. Further, since the charged particles are prevented from colliding with the magnetic field forming means, production of new contaminants such as sputtered materials can be suppressed. Therefore, the reflectance reduction of the EUV collector mirror and the absorption of EUV light due to accumulation of charged particles are suppressed, and thereby, the utilization efficiency of EUV light can be improved.

### BRIEF DESCRIPTION OF THE DRAWINGS

FIGS. 1A and 1B show a configuration of an extreme ultra violet light source apparatus according to the first embodiment of the present invention;

FIG. 2 is a diagram for explanation of shapes of electromagnets shown in FIGS. 1A and 1B;

FIG. 3 shows a first modified example of the electromagnets used in the extreme ultra violet light source apparatus according to the first embodiment of the present invention;

FIG. 4 shows a second modified example of the electromagnets used in the extreme ultra violet light source apparatus according to the first embodiment of the present invention;

FIG. 5 shows a third modified example of the electromagnets used in the extreme ultra violet light source apparatus according to the first embodiment of the present invention;

FIG. 6 shows a fourth modified example of the electromagnets used in the extreme ultra violet light source apparatus according to the first embodiment of the present invention;

FIG. 7 shows a fifth modified example of the electromagnets used in the extreme ultra violet light source apparatus according to the first embodiment of the present invention;

FIG. 8 shows a sixth modified example of the electromagnets used in the extreme ultra violet light source apparatus according to the first embodiment of the present invention;

FIGS. 9A and 9B show a configuration of an extreme ultra violet light source apparatus according to the second embodiment of the present invention;

FIG. 10 shows a configuration of an extreme ultra violet light source apparatus according to the third embodiment of the present invention;

FIGS. 11A-11C show a configuration of an extreme ultra violet light source apparatus according to the fourth embodiment of the present invention;

FIG. 12 is an enlarged view showing the configuration of the extreme ultra violet light source apparatus according to the fourth embodiment of the present invention;

FIG. 13 is a diagram for explanation of a principle of generating EUV light in an LPP type extreme ultra violet light source apparatus;

FIG. 14 shows a mirror magnetic field formed by electromagnets; and

FIG. 15 shows a mirror magnetic field formed by electromagnets having iron cores.

### DESCRIPTION OF THE PREFERRED EMBODIMENTS

Hereinafter, preferred embodiments of the present invention will be explained in detail by referring to the drawings. The same reference numerals are assigned to the same component elements and the description thereof will be omitted.

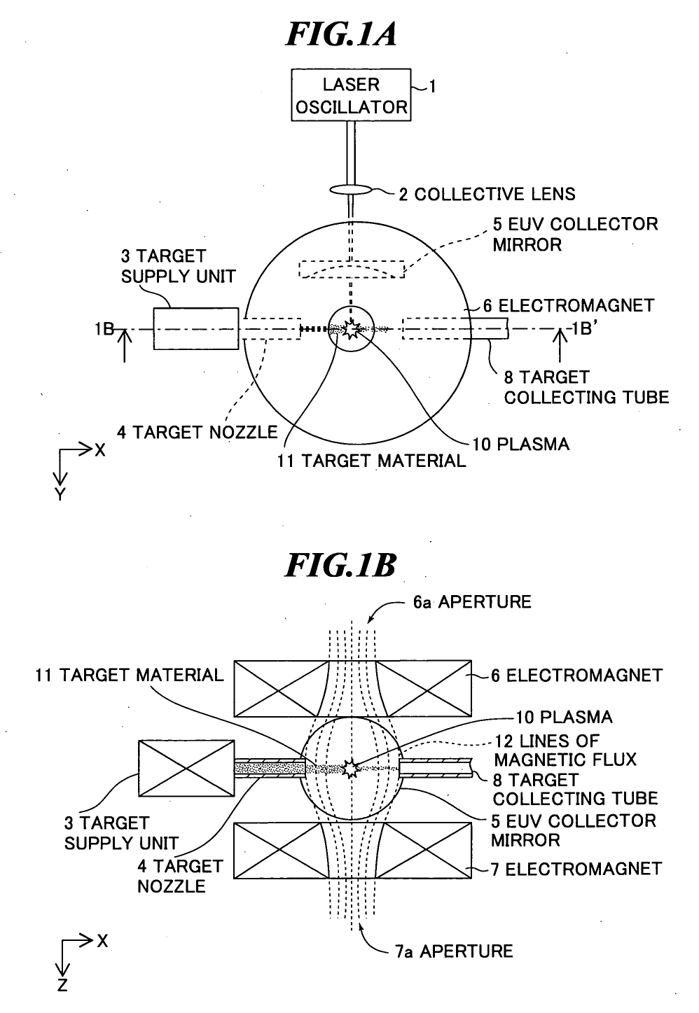

FIG. 1A is a schematic diagram showing a configuration of an extreme ultra violet (EUV) light source apparatus according to the first embodiment of the present invention, and FIG. 1B is a sectional view along a dashed-dotted line 1B-1B′ shown in FIG. 1A. The EUV light source apparatus employs a laser produced plasma (LPP) type of generating EUV light by applying a laser beam to a target material for excitation.

As shown in FIGS. 1A and 1B, the EUV light source apparatus includes a laser oscillator 1, a collective lens 2, a target supply unit 3, a target nozzle 4, an EUV collector mirror 5, and electromagnets 6 and 7 respectively including coils. The coils of these electromagnets 6 and 7 are connected to wiring and power supply for supplying current. Although part of the components shown in FIGS. 1A and 1B are held in a vacuum chamber, the vacuum chamber is omitted in FIGS. 1A and 1B.

The laser oscillator 1 is a laser light source capable of pulse oscillation at a high repetition frequency, and outputs a laser beam to be applied to a target material, which will be described later, and to excite the target material. Further, the collective lens 2 is a focusing optics for focusing the laser beam outputted from the laser oscillator 1 in a predetermined position. Although one collective lens 2 is used as the focusing optics in the embodiment, the focusing optics may be configured by a combination of other focusing optical components or plural optical components.

The target supply unit 3 supplies the target material, that is excited and plasmarized when the laser beam is applied thereto, to the target nozzle 4. As the target material, xenon (Xe), mixture with xenon as the main component, argon (Ar), krypton (Kr), water (H₂O) or alcohol, which are in a gas state in a low-pressure condition, molten metal such as tin (Sn) and lithium (Li), water or alcohol in which fine metal particles of tin or tin oxide are dispersed, an ionic solution of lithium fluoride (LiF) or lithium chloride (LiCl) solved in water, or the like is used.

The state of the target material may be gas, liquid, or solid. When a target material in a gas state at the normal temperature, for example, xenon is used as a liquid target, the target supply unit 3 pressurizes or cools the xenon gas for liquefaction and supplies it to the target nozzle 4. On the other hand, when a material in a solid state at the normal temperature, for example, tin is used as a liquid target, the target supply unit 3 heats tin for liquefaction and supplies it to the target nozzle 4.

The target nozzle 4 injects a target material 11 supplied from the target supply unit 3 to form a target jet or droplet target. When the droplet target is formed, a mechanism of vibrating the target nozzle 4 (e.g., piezoelectric element) at a predetermined frequency is further provided. Further, in this case, the pulse oscillation interval in the laser oscillator 1 is adjusted to the position interval of the droplet target (or time interval of formation).

The plasma 10 is generated by applying the laser beam to the target material 11 injected from the target nozzle 4, and light having various wavelength components is emitted therefrom.

The EUV collector mirror 5 is a collecting optics for collecting components having a predetermined wavelength (e.g., EUV light near 13.5 nm) of the various wavelength components radiated from the plasma 10. The EUV collector mirror 5 has a concave reflection surface, and, for example, a molybdenum (Mo)/silicon (Si) multilayer film for selectively reflecting the EUV light near 13.5 nm is formed on the reflection surface. By the EUV collector mirror 5, the EUV light is reflected and collected in a predetermined direction (downward in FIG. 1), and outputted to the exposure equipment, for example. The collecting optics of EUV light is not limited to the collector mirror as shown in FIGS. 1A and 1B, but may be configured by using plural optical components. However, the collecting optics must be a reflecting optics in order to suppress absorption of EUV light.

The electromagnets 6 and 7 are oppositely provided in parallel or substantially in parallel with each other such that the centers of apertures 6a and 7a of the electromagnets 6 and 7 are aligned. Here, since the electromagnets 6 and 7 are used within the vacuum chamber, in order to keep the degree of vacuum within the chamber and prevent emission of contaminants, the coil winding and the cooling mechanism of the coil winding are put into an airtight container covered by a non-magnetic metal such as stainless or ceramics, and thereby, the coil winding and so on are separated from the vacuum space within the chamber. In this application, the reference to the electromagnet includes the coil winding, the airtight container including the winding, and so on.

The coils of these electromagnets 6 and 7 form a pair of mirror coils. The mirror coils form a mirror magnetic field in a region including a plasma emission point (the position where the laser beam is applied to the target material) when currents flowing in the same direction are supplied thereto. Here, the mirror magnetic field refers to a magnetic field having high magnetic flux density near the coils of the electromagnets 6 and 7 and low magnetic flux density at the mid point between the coils. Here, typically, in a mirror magnetic field used for magnetic confinement fusion or the like, the magnetic field is designed at a high mirror ratio for improvement in confinement effect of ions and plasma. However, in the embodiment, in order to efficiently eject ions in the direction of lines of magnetic flux (Z-axis direction), the electromagnets 6 and 7 or yokes are designed such that the mirror ratio is low. Here, the mirror ratio refers to the maximum magnetic flux density B₁ near the coil to the minimum magnetic flux density B₀ at the mid point between the two coils (i.e., B₁/B₀).

Further, the apertures 6a and 7a are formed in the electromagnets 6 and 7 according to lines of magnetic flux 12 formed by the electromagnets. The shape of the apertures will be explained in detail later.

The target collecting tube 8 is located in the position facing the target nozzle 4 with the plasma emission point (the position where the laser beam is applied to the target material) in between. The target collecting tube 8 collects the target material that has not been irradiated with the laser beam or plasmarized though injected from the target nozzle 4. Thereby, contamination of the ETV collector mirror 5 and so on due to flying of the unwanted target material is prevented and the reduction in the degree of vacuum within the chamber is suppressed.

In the configuration, when the laser beam is -applied to the target material 11, the plasma 10 is generated and EUV light is radiated from the plasma. Concurrently, the charged particles such as ions are also emitted from the plasma 10. The ions may collide with parts around including the EUV collector mirror 5 and cause contamination and deterioration of the parts under the normal circumstances. Accordingly, in the embodiment, those ions are ejected to the outside of the electromagnets 6 and 7 (i.e., to the outside of the EUV collector mirror 5) by the action of the mirror magnetic field. That is, the ion having a velocity component orthogonal to the lines of the magnetic flux 12 is subjected to a force in the tangential direction to a circle around the lines of the magnetic flux 12 and trapped near the lines of the magnetic flux 12. In this regard, when the ion also has a velocity component in parallel to the lines of the magnetic flux 12, the ion moves along the lines of the magnetic flux 12 and passes through the apertures 6a and 7a , and is ejected to the outside. Further, the ion having only a velocity component in parallel to the lines of the magnetic flux 12 also passes through the apertures 6a and 7a and is ejected to the outside.

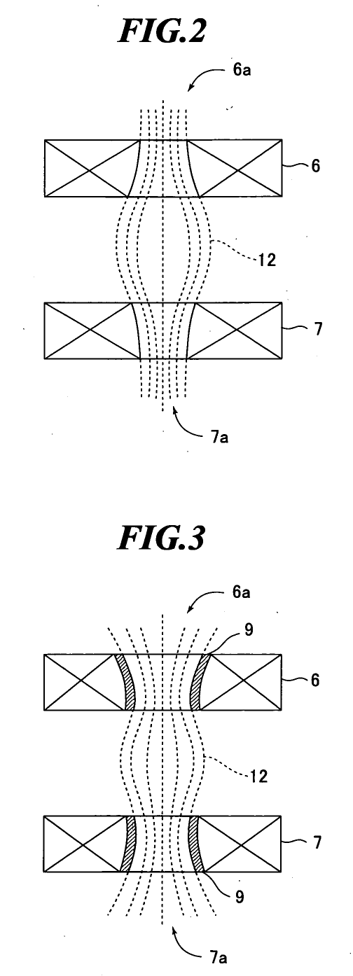

FIG. 2 is a diagram for explanation of the shapes of the electromagnets 6 and 7 shown in FIGS. 1A and 1B. Here, members such as iron cores are not provided in the electromagnets, typically, the magnetic flux density near the mid point between the coil of the electromagnet 6 and the coil of the electromagnet 7 (i.e., near the plasma emission point) is low and the magnetic flux density near the apertures 6a and 7a of the electromagnets 6 and 7 is high. Accordingly, the lines of the magnetic flux 12 widely spaced near the plasma emission point and converged toward the apertures 6a and 7a are formed. In the embodiment, the inner wall surfaces of the apertures 6a and 7a may be shaped along the lines of the magnetic flux 12 such that the lines of the magnetic flux 12 may not cut through the electromagnets 6 and 7. The configuration with no members such as iron cores in the electromagnets is used in typical electromagnets and superconducting magnets.

The shapes of the inner wall surfaces of the apertures 6a and 7a may be designed based on lines of magnetic flux obtained, for example, by measurement or simulation of magnetic flux density of the magnetic field formed by the electromagnets 6 and 7. For this, a range in which the change of the magnetic flux density is smaller than a predetermined value (e.g., one millitesla) may not be considered. The change of the magnetic field in the range has an insignificant effect on the movement of ions emitted from the plasma.

By shaping the inner wall surfaces of the apertures 6a and 7a along the lines of the magnetic flux 12, the ions moving along the lines of the magnetic flux 12 can be ejected without colliding with the bottom surfaces of the electromagnets 6 and 7 and the inner wall surfaces of the apertures 6a and 7a . Thereby, the ejection speed can be improved without hindering the ion flow. Therefore, even when the EUV light is generated at a high repetition frequency, the increase in the concentration of ions staying near the plasma emission point can be suppressed. That is, the absorption of EUV light by the ions is suppressed, and thereby, the reduction in utilization efficiency of the EUV light can be suppressed.

Further, the collision of ions with the electromagnets 6 and 7 is avoided, and thereby, the damage on them is suppressed and the lives can be extended. Furthermore, the production of new contaminants such as sputtered materials due to collision of ions can be suppressed, and thereby, the contamination and damage on the components can be prevented. Therefore, the reduction in utilization efficiency of the EUV light due to reflectance reduction of the EUV collector mirror 5 can be suppressed. As a result, the reduction in cost at operation of the EUV light source apparatus and the reduction in cost at maintenance and replacement of parts are realized, and further, the improvement in utilization rate of the exposure equipment using the EUV light source apparatus and the improvement in productivity of semiconductor devices using the exposure equipment can be realized.

FIG. 3 shows a first modified example of the electromagnets used in the extreme ultra violet light source apparatus according to the first embodiment of the present invention.

As shown in FIG. 3, in the modified example, yokes 9 are provided to the electromagnets 6 and 7 shown in FIG. 2. The yoke is a member used for inducing magnetic flux, and not only steel materials such as electromagnetic soft iron, silicon steel plate, and carbon steel plate but also a magnetic material including nickel or the like is used as a material of the yoke. In this case, the magnetic flux density of the magnetic field formed by the coils of the electromagnets 6 and 7 is the highest within the apertures 6a and 7a . Accordingly, the shape of the lines of the magnetic flux becomes the narrowest within the apertures 6a and 7a and is diverged from there toward the outside. In this modified example, the wall surfaces of the apertures 6a and 7a are shaped to be slightly broader toward the outside of the electromagnets 6 and 7 along the lines of the magnetic flux 12.

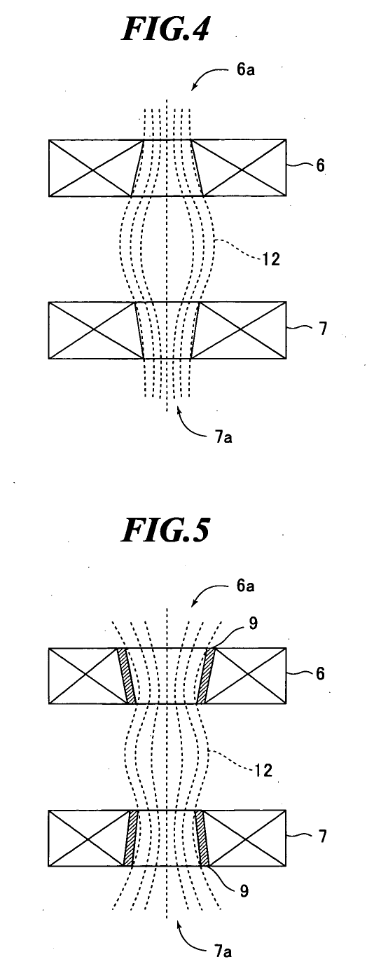

FIG. 4 shows a second modified example of the electromagnets used in the extreme ultra violet light source apparatus according to the first embodiment of the present invention.

As shown in FIG. 4, in the modified example, in the configuration without yokes provided in the electromagnets 6 and 7, the wall surfaces of the apertures 6a and 7a are formed in truncated conical shapes with diameters smaller toward the outside of the electromagnets 6 and 7. In this case, the lines of the magnetic flux 12 are generally along the apertures 6a and 7a , and thereby, the lines of the magnetic flux 12 converged toward the outside can be prevented from cutting through the electromagnets 6 and 7. Further, since the shapes of the wall surfaces of the apertures 6a and 7a are simple and easily designed, the manufacturing cost can be reduced.

FIG. 5 shows a third modified example of the electromagnets used in the extreme ultra violet light source apparatus according to the first embodiment of the present invention.

As shown in FIG. 5, in the modified example, in the configuration with yokes provided in the electromagnets 6 and 7, the wall surfaces of the apertures 6a and 7a are formed in truncated conical shapes with diameters larger toward the outside of the electromagnets 6 and 7. In this case, the lines of the magnetic flux 12 are generally along the apertures 6a and 7a , and thereby, the lines of the magnetic flux 12 diverged toward the outside can be prevented from cutting through the electromagnets 6 and 7. Further, since the shapes of the wall surfaces of the apertures 6a and 7a are simple and easily designed, the manufacturing cost can be reduced.

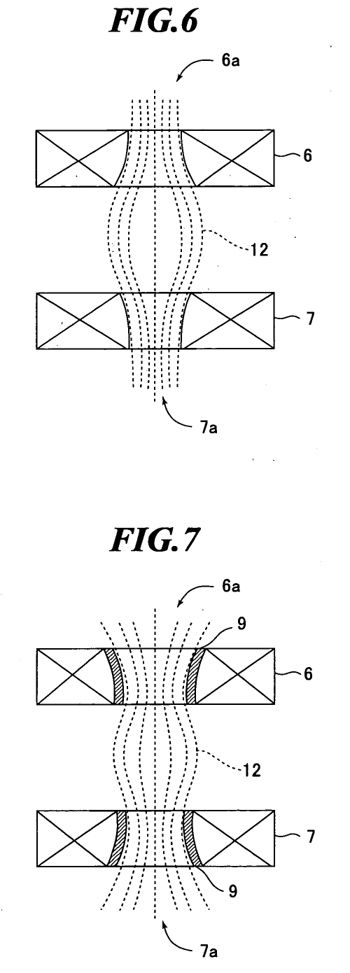

FIG. 6 shows a fourth modified example of the electromagnets used in the extreme ultra violet light source apparatus according to the first embodiment of the present invention.

As shown in FIG. 6, in the modified example, in the configuration without yokes provided in the electromagnets 6 and 7, the wall surfaces of the apertures 6a and 7a are formed in funnel shapes with diameters smaller toward the outside of the electromagnets 6 and 7. In this case, the lines of the magnetic flux 12 are generally along the apertures 6a and 7a , and thereby, the lines of the magnetic flux 12 converged toward the outside can be prevented from cutting through the electromagnets 6 and 7. Further, since the shapes of the wall surfaces of the apertures 6a and 7a are simpler and more easily designed than the shapes shown in FIG. 2, the manufacturing cost can be reduced.

FIG. 7 shows a fifth modified example of the electromagnets used in the extreme ultra violet light source apparatus according to the first embodiment of the present invention.

As shown in FIG. 7, in the modified example, in the configuration with yokes provided in the electromagnets 6 and 7, the wall surfaces of the apertures 6a and 7a are formed in funnel shapes with diameters larger toward the outside of the electromagnets 6 and 7. In this case, the lines of the magnetic flux 12 are generally along the center apertures 6a and 7a , and thereby, the lines of the magnetic flux 12 diverged toward the outside can be prevented from cutting through the electromagnets 6 and 7. Further, since the shapes of the wall surfaces of the apertures 6a and 7a are simpler and more easily designed than the shapes shown in FIG. 3, the manufacturing cost can be reduced.

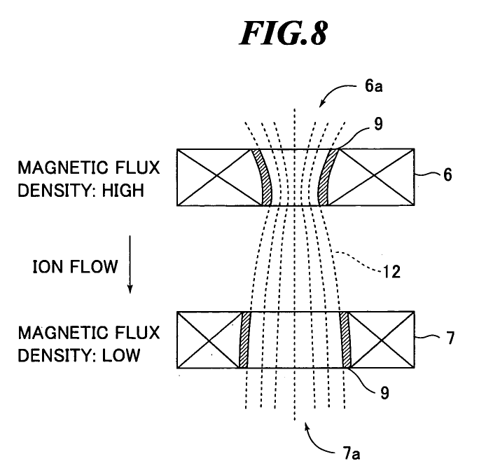

FIG. 8 shows a sixth modified example of the electromagnets used in the extreme ultra violet light source apparatus according to the first embodiment of the present invention.

In the modified example, the two electromagnets 6 and 7 are allowed to generate magnetic fields different in intensity from each other such that the magnetic flux density is high at the electromagnet 6 side and the magnetic flux density is lower in the electromagnet 7. Thereby, an asymmetric magnetic field is formed relative to a surface orthogonal to the central axis of the lines of the magnetic flux 12. The wall surfaces of the apertures 6a and 7a are formed along the asymmetric magnetic field.

In the asymmetric magnetic field, the charged particles having a velocity component in parallel to the lines of the magnetic flux 12 are typically guided to the lower magnetic flux density. Accordingly, in FIG. 8, many of the ions generated from the plasma are guided downward in the drawing and ejected through the aperture 7a to the outside of the electromagnet 7. In this manner, the ejection efficiency of ions can be improved by forming the direction of the ion flow.

In order to generate magnetic fields different in intensity from each other in the two electromagnets 6 and 7, for example, the intensity of the currents flowing in the coils of the electromagnets 6 and 7 may be made different from each other, or the number of turns or the diameters of turns per unit length may be made different from each other. Alternatively, those methods may be combined. Although the configuration in which the yokes 9 are provided in the electromagnets 6 and 7 has been shown in FIG. 8, a configuration with no yokes may be employed. In this case, the shapes of the wall surfaces of the apertures 6a and 7a may be designed according to the shape of the lines of the magnetic flux. Further, an asymmetric magnetic field may be formed by providing a yoke in only one of the electromagnets 6 and 7.

In the modified example, the wall surfaces of the apertures 6a and 7a may have truncated conical shapes or funnel shapes close to the shape of the lines of the magnetic flux 12.

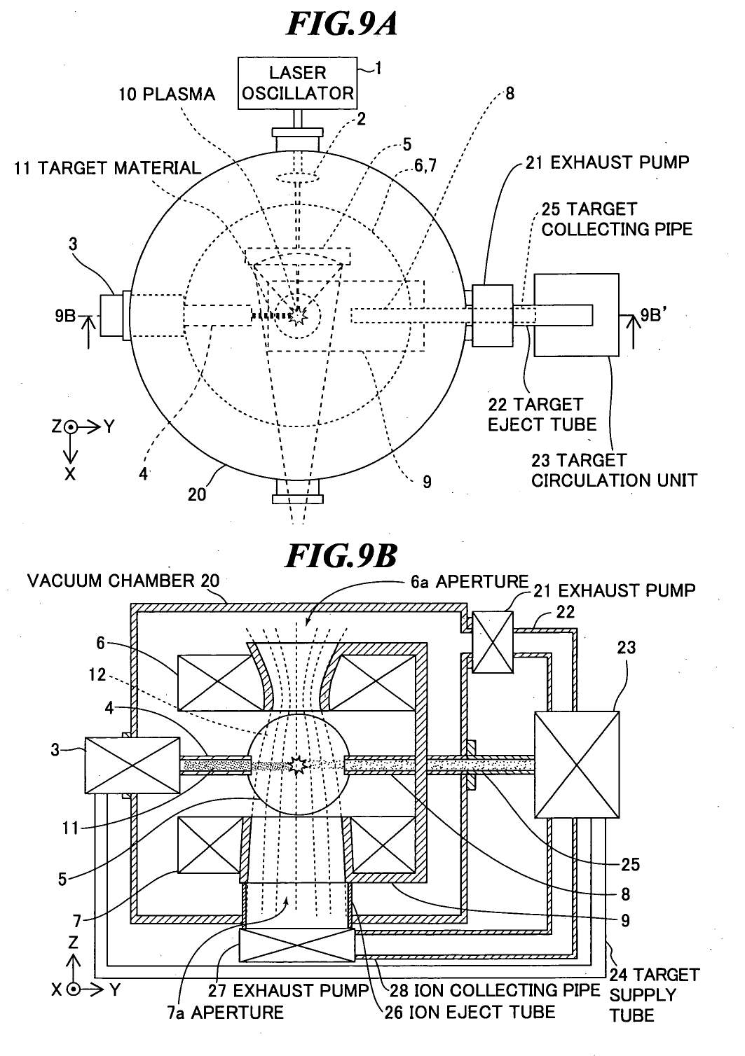

Next, an extreme ultra violet light source apparatus according to the second embodiment of the present invention will be explained. FIG. 9A is a plan view showing a configuration of the extreme ultra violet light source apparatus according to the second embodiment of the present invention, and FIG. 9B is a sectional view along 9B-9B′ shown in FIG. 9B.

The extreme ultra violet light source apparatus according to the embodiment is provided with a mechanism of ejecting ions generated from plasma from a vacuum chamber.

As shown in FIGS. 9A and 9B, in a vacuum chamber 20, the collective lens 2, the target nozzle 4, the EUV collector mirror 5, and the electromagnets 6 and 7 with yokes 9, and the target collecting tube 8 are provided. The operation and positional relationship of these components are the same as those explained in the first embodiment. Note that the electromagnets 6 and 7 of the sixth modified example shown in FIG. 8 are illustrated.

Furthermore, the vacuum chamber 20 is provided with a target eject tube 22 including an exhaust pump 21, a target circulation unit 23, a target supply tube 24, a target collecting pipe 25, an ion eject tube 26, an exhaust pump 27, and an ion collecting pipe 28.

The target eject tube 22 is a passage for ejecting the target material remaining within the vacuum chamber 20 to the outside of the chamber 20.

The target circulation unit 23 is a unit for reusing the collected target material, and includes a suction power source (suction pump), a refinement mechanism of the target material, and a pressure feed power source (pressure feed pump). The target circulation unit 23 suctions and collects the target material via the target eject tube 22, refines it in the refinement mechanism, and pressure-feeds it via the target supply tube 24 to the target supply unit 3.

Although the target circulation unit 23 also has an exhaust function, the exhaust pump 21 is provided in the target eject tube 22 to aid the function in the embodiment.

The target collecting pipe 25 transports the target material collected by the target collecting tube 8 to the target circulation unit 23. The collected target is refined and reused in the target circulation unit 23.

The ion eject tube 26 is provided to connect to the aperture 7a of the electromagnet 7. The ion eject tube 26 and the exhaust pump 27 eject the ions guided to the outside of the electromagnet 7 by the action of the magnetic field to the outside of the vacuum chamber 20. The ejected ions are collected through the ion collecting pipe 28 into the target circulation unit 23 and reused.

According to the embodiment, the movement of the ions guided out by the action of the magnetic field is promoted by the exhaust pump 27, and thereby, the ejection efficiency of ions can be improved. Further, by connecting the ion eject tube 26 to the aperture 7a , the ions once guided to the outside of the electromagnet 7 can be prevented from diffusing within the vacuum chamber 20 and ejected reliably.

In the embodiment, the electromagnets 6 and 7 having the configurations shown in FIGS. 2-7 may be used. In this case, it is preferable that the ion eject tube 26, the exhaust pump 27, and the ion collecting pipe 28 are also provided at the aperture 6a side because the ions emitted from the plasma are generally homogeneously guided out to both of the apertures 6a and 7a.

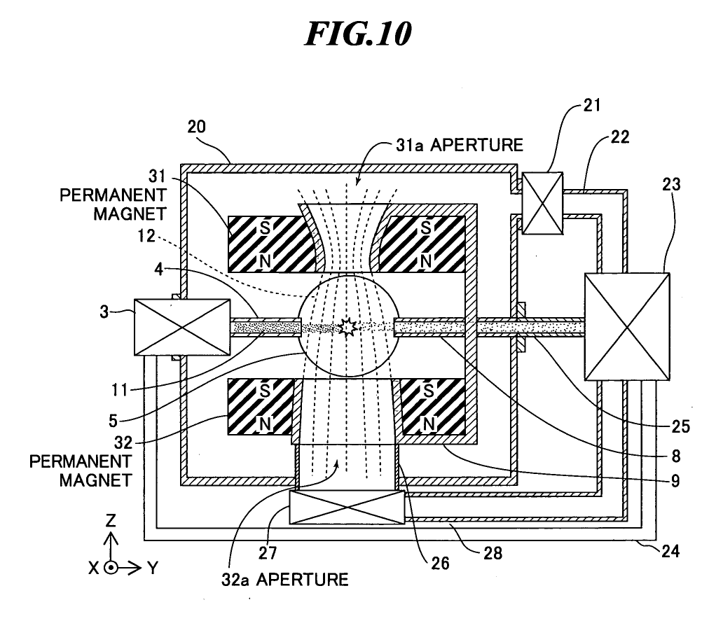

Next, an extreme ultra violet light source apparatus according to the third embodiment of the present invention will be explained. FIG. 10 is a sectional view showing a configuration of the extreme ultra violet light source apparatus according to the third embodiment of the present invention.

The extreme ultra violet light source apparatus according to the embodiment is provided with permanent magnets 31 and 32 in place of the electromagnets 6 and 7 shown in FIGS. 9A and 9B. The rest of the configuration is the same as that shown in FIGS. 9A and 9B.

Apertures 31a and 32a are formed in the permanent magnets 31 and 32, respectively. The wall surfaces of the apertures 31a and 32a have shapes along the lines of the magnetic flux 12. Alternatively, the wall surfaces of the apertures 31a and 32a may have truncated conical shapes or funnel shapes close to the shape of the lines of the magnetic flux 12. Further, the ion eject tube 26 is provided to connect to the aperture 32a . Although the yokes 9 are provided in the embodiment, a configuration with no yokes may be employed.

In FIG. 10, an asymmetric magnetic field is formed relative to a surface orthogonal to the central axis of the lines of the magnetic flux by using magnets generating magnetic fields different in intensity from each other as the permanent magnets 31 and 32. Thereby, many of the ions emitted from the plasma are guided out along the lines of the magnetic flux 12 toward the lower magnetic flux density (downward in FIG. 10). Alternatively, magnets generating magnetic fields having the same intensity may be used as the permanent magnets 31 and 32. In this case, a symmetric magnetic field is formed relative to a surface orthogonal to the central axis of the lines of the magnetic flux, and it is desirable that the ion eject tube 26, the exhaust pump 27, and the ion collecting pipe 28 are also provided at the aperture 31a side in consideration of the ions guided out in both directions of the lines of the magnetic flux 12.

According to the embodiment, since the permanent magnets are used as magnetic field forming means, the number of parts provided within the vacuum chamber 20 is reduced, and thereby, the configuration can be simplified.

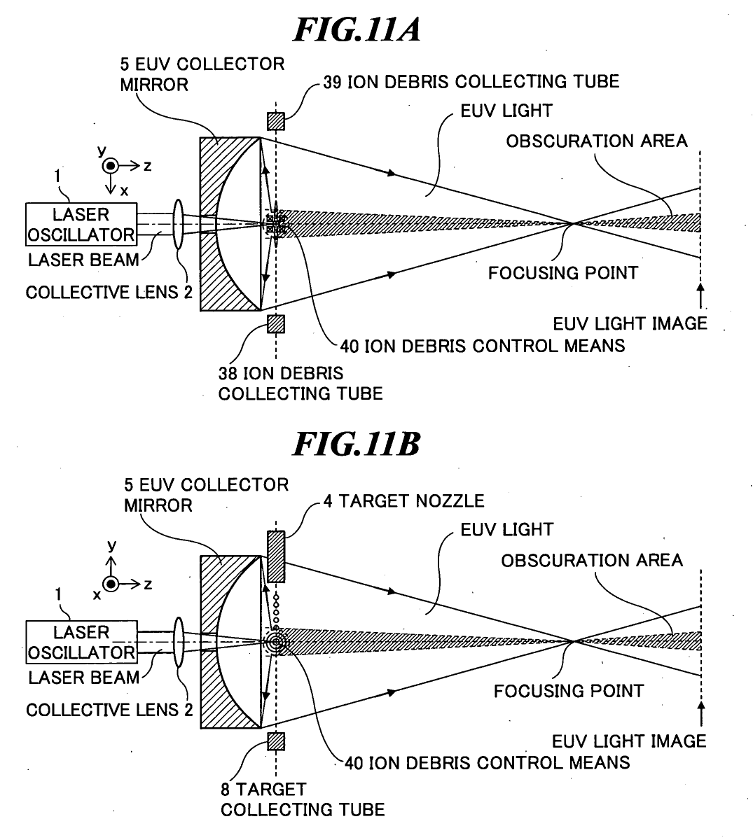

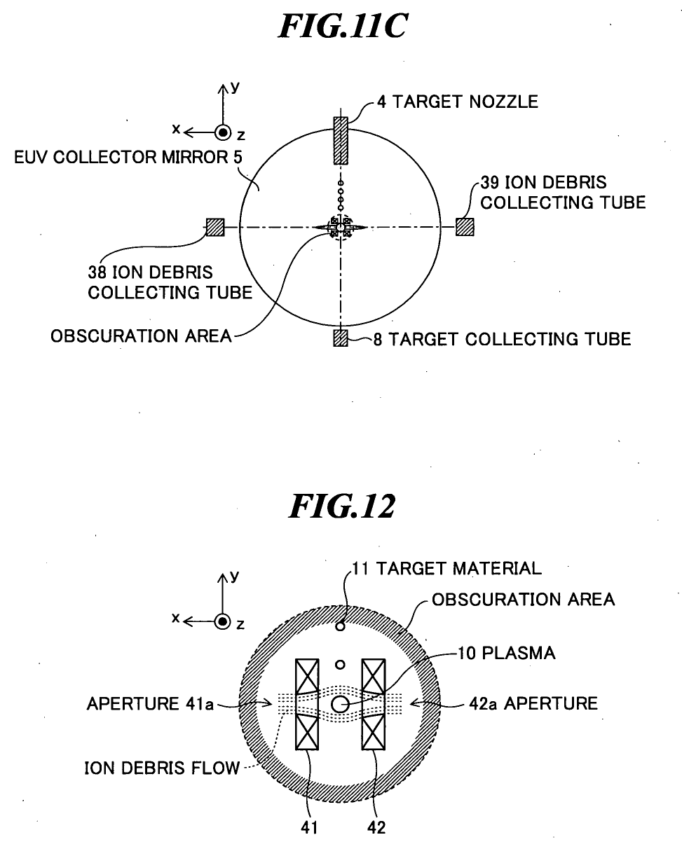

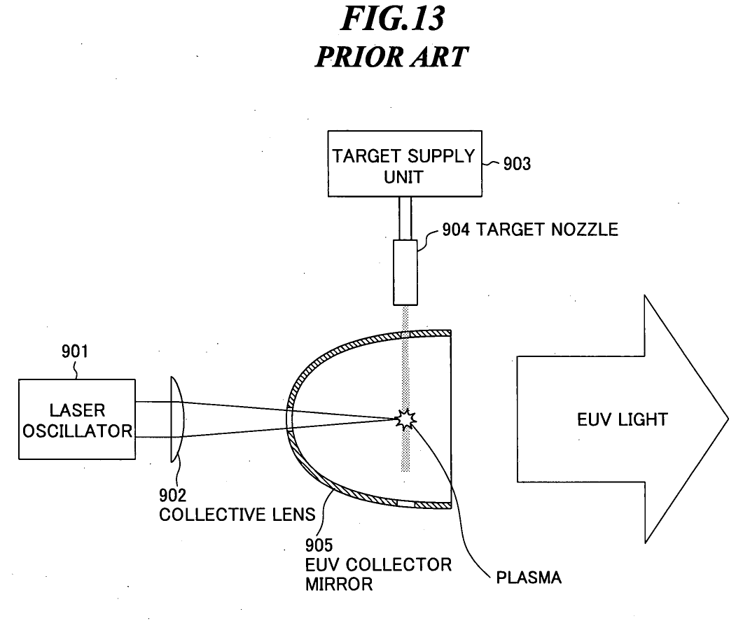

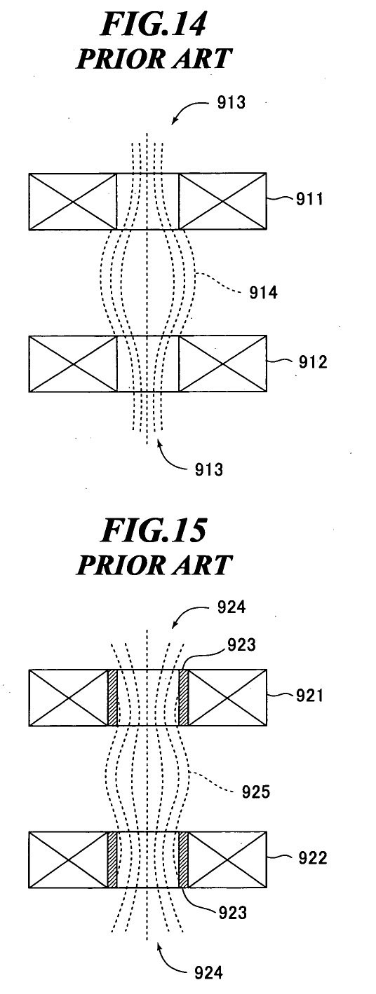

Next, an extreme ultra violet light source apparatus according to the fourth embodiment of the present invention will be explained. FIG. 11A is a top sectional view showing a configuration of the extreme ultra violet light source apparatus according to the fourth embodiment of the present invention, FIG. 11B is a side sectional view showing the configuration of the extreme ultra violet light source apparatus according to the fourth embodiment of the present invention, FIG. 11C is a front view showing the configuration of the extreme ultra violet light source apparatus according to the fourth embodiment of the present invention, and FIG. 12 is an enlarged front view showing the configuration of the extreme ultra violet light source apparatus according to the fourth embodiment of the present invention.

As shown in FIGS. 11A-11C, the EUV light source apparatus has the laser oscillator 1, the collective lens 2, the target nozzle 4, the EUV collector mirror 5, the target collecting tube 8, ion debris collecting tubes 38 and 39, ion debris control means 40 including two small electromagnets. Although part of the components shown in FIGS. 11A-11C is held in a vacuum chamber, the vacuum chamber is omitted in FIGS. 11A-11C.

In the EUV light source apparatus according to the embodiment, the two small electromagnets are provided to surround the plasma emission point within an obscuration area. Here, the obscuration area refers to an area corresponding to an angle range in which the EUV light collected by the EUV collector mirror 5 is not used in an exposure unit.

Those small electromagnets are provided within the obscuration area, and do not shield the EUV light to be used in the exposure unit. Further, since the electromagnets are small, they are held within the vacuum chamber, there is no interference with the exposure unit, and the leakage magnetic field is small. Since the magnetic flux density abruptly attenuates as the distance is longer, the magnetic field is hardly generated outside of the EUV light source apparatus.

As shown in FIG. 12, the small electromagnets 41 and 42 of the ion debris control means 40 are provided to surround the plasma 10. The electromagnets 41 and 42 are connected to wiring and power supply for supplying current. Since the distance between the two coils is several millimeters, even the small electromagnets can apply a local magnetic field of several of teslas to the plasma emission point.

The small electromagnets 41 and 42 are oppositely provided in parallel or substantially in parallel with each other such that the centers of the apertures 41a and 42a of the small electromagnets 41 and 42 are aligned. Here, in the small electromagnets 41 and 42, the apertures 41a and 42a are formed according to the lines of the magnetic flux of the magnetic field formed by them.

Since the small electromagnets 41 and 42 are used near the plasma 10 within the vacuum chamber, in order to keep the degree of vacuum within the chamber and prevent emission of contaminants, the coil winding and the cooling mechanism of the coil winding are put into an airtight container covered by a non-magnetic metal such as stainless or ceramics, and thereby, the coil winding and so on are separated from the vacuum space within the chamber.

The coils of these small electromagnets 41 and 42 form a pair of mirror coils. The mirror coils form a mirror magnetic field in a region including the plasma emission point (the position where the laser beam is applied to the target material) when currents flowing in the same direction are supplied thereto.

Therefore, the ion debris generated from the plasma 10 flow in the direction of the magnetic field, and pass through the apertures 41a and 42a of the small electromagnets 41 and 42 and flow to the outside. In this regard, the ion debris move along the shape of the magnetic field, and thus, the ion debris can be prevented from colliding with and sputtering the small electromagnets 41 and 42 by conforming the shapes of the apertures 41a and 42a to the shape of the magnetic field.

1. A laser produced plasma type extreme ultra violet light source apparatus comprising:
a target nozzle for supplying a target material;
a laser oscillator for applying a laser beam to the target material supplied by said target nozzle to generate plasma;
a collecting optics for collecting extreme ultra violet light radiated from the plasma; and
magnetic field forming means for forming a magnetic field in a position where the laser beam is applied to said target material, wherein an aperture of said magnetic field forming means is formed according to a shape of lines of magnetic flux of the magnetic field.

2. The extreme ultra violet light source apparatus according to claim 1, wherein an inner wall surface of the aperture has a shape along the lines of the magnetic flux.

3. The extreme ultra violet light source apparatus according to claim 1, wherein an inner wall surface of the aperture has one of a truncated conical shape and a funnel shape.

4. The extreme ultra violet light source apparatus according to claim 1, wherein said magnetic field forming means forms an asymmetric magnetic field relative to a surface orthogonal to a central axis of the lines of the magnetic flux.

5. The extreme ultra violet light source apparatus according to claim 1, wherein said magnetic field forming means includes a yoke.

6. The extreme ultra violet light source apparatus according to claim 1, wherein said magnetic field forming means includes a permanent magnet.

7. The extreme ultra violet light source apparatus according to claim 1, wherein said magnetic field forming means includes a superconducting magnet.

8. The extreme ultra violet light source apparatus according to claim 1, further comprising:
exhausting means provided to be connected to the aperture of said magnetic field forming means.

9. The extreme ultra violet light source apparatus according to claim 1, wherein said magnetic field forming means includes two electromagnets provided in an area corresponding to an angle range in which the EUV light collected by said collecting optics is not used in an exposure unit, and an aperture of each of said two electromagnets is formed according to the shape of lines of magnetic flux of the magnetic field.
